(19) United States
(12) Patent Application Publication
(10) Pub. No.: US 2011/0130321 A1
(43) Pub. Date: Jun. 2, 2011

(54) HEAT-SENSITIVE EMULSIONS

(75) Inventors: Katerina Karagianni, Paris (FR); Mathias Destarac, Toulouse (FR)

(73) Assignee: Rhodia Operations, Aubervilliers (FR)

(21) Appl. No.: 13/002,716

(22) PCT Filed: Jul. 22, 2009
(86) PCT No.: PCT/EP2009/059434

§ 371 Date: Feb. 14, 2011

(30) Foreign Application Priority Data
Jul. 23, 2008 (FR) 08/04189

(51) Int. Cl. C11D 3/37

(52) U.S. Cl. 510/513

(57) ABSTRACT

The invention relates to heat-sensitive emulsions that can be destabilized by increasing the temperature. The emulsions include a copolymer with amphiphilic blocks.

The present invention relates to heat-sensitive emulsions that can be destabilized by increasing the temperature. The emulsions comprise an amphiphilic block copolymer.

In many fields, especially in the fields of cosmetics and pharmacy, and household maintenance, formulations are prepared in the form of emulsions comprising a dispersed organic phase (oil-in-water emulsion), which are intended to give a property to a medium or a surface. It is typically sought to control the formation of emulsions, their stability and their behavior under the effect of an involuntarily experienced or voluntarily applied external parameter.

It is known practice to use copolymers with a lower critical solubility temperature, known as the LOST, as formulation ingredients.

For example, document WO 02/055 607 (L'Oréal) describes comb (grafted) copolymers with a hydrophilic backbone, for example derived from polyacrylic acid, and LCST grafts of poly-N-isopropylacrylamide (pNIPAM) or LCST grafts comprising a polyether group. That document also suggests block copolymers, used for improving the stability of formulations, especially cosmetic creams, when they are subjected to different temperatures, by formation of a gel during a temperature increase. However, the copolymers used do not make it possible to control the formation of the emulsion and/or to trigger destabilization and/or deposition of the dispersed phase.

Document WO 03/049 848 (Rhodia) describes the use in an emulsion of an amphiphilic block copolymer, one block of which is hydrophobic and one block of which comprises cationic units, for aiding the deposition of a dispersed hydrophobic phase during dilution. However, the copolymers and emulsions are not temperature-sensitive.

Document WO 2007/012 763 (Rhodia) describes block copolymers comprising an LCST block and a block of polyorganosiloxane type. However, such copolymers are expensive and/or complex to prepare (their synthesis requires several steps).

There is a need for other block copolymers and for other emulsions comprising them. There is especially a need for heat-sensitive emulsions, allowing control of the stabilization and/or destabilization and/or deposition of the dispersed phase as a function of the temperature.

The invention satisfies at least one of the needs expressed above, or at least one of the limits expressed above, by proposing an emulsion comprising an external aqueous phase, a liquid organic phase dispersed in the aqueous phase, and an amphiphilic linear block copolymer comprising a hydrophilic block A and a hydrophobic block B, characterized in that:
block A is a block with a lower critical solubility temperature (LCST) comprising units A_{LCST} with a lower critical solubility temperature (LCST),
block B is a hydrophobic block, comprising hydrophobic units B, and
block A and block B are derived from ethylenically unsaturated monomers.

The invention also relates to the amphiphilic block copolymer per se. The invention also relates to the use of the copolymer in the emulsion. It may especially be used as an emulsifier and/or coemulsifier and/or as an agent for triggering destabilization of the emulsion by increasing the temperature of the emulsion and/or as an agent for bringing about deposition, preferably by destabilization of the emulsion, of at least part of the organic phase, onto a surface to be treated. The invention also relates to a process for preparing the emulsion. The invention also relates to a process of emulsification and/or of co-emulsification and/or of triggering of destabilization of an emulsion by increasing the temperature of the emulsion and/or of deposition, preferably by destabilization of an emulsion, of at least part of the organic phase, onto a surface to be treated. The invention also relates to compositions for treating and/or modifying surfaces, of which the emulsion forms a part. It may especially be a cosmetic composition (the surface possibly being the skin and/or the hair) or a textile care composition, for example a laundry product or a fabric softener.

### DEFINITIONS

In the present patent application, the term linear block copolymer means a copolymer containing at least two blocks of different compositions, connected together, and forming a linear macromolecular chain. It is not excluded for the blocks to bear macromolecular side groups. These groups, when they exist, will not be considered as blocks of the block copolymer.

In the present patent application, the abbreviation LCST denotes the lower critical solubility temperature.

According to the invention, the term “A_{LCST} unit” means either a unit derived from the polymerization of a monomer whose corresponding homopolymer has an LCST, or a unit derived from the polymerization of a macromonomer with an LOST.

In the present patent application, a unit derived from a monomer denotes a unit that may be obtained directly from said monomer by polymerization. Thus, for example, a unit derived from an acrylic or methacrylic or vinylic acid ester does not cover a unit of formula —CH₂—CH(COOH)—, —CH₂—C(CH₃)(COOH)— or —CH₂—CH(OH)—, respectively, obtained, for example, by polymerizing an acrylic or methacrylic acid ester, or vinyl acetate, respectively, followed by hydrolysis. A unit derived from acrylic or methacrylic acid covers, for example, a unit obtained by polymerizing a monomer (for example an acrylic or methacrylic acid ester), followed by reacting (for example by hydrolysis) the polymer obtained so as to obtain units of formula —CH₂—CH(COOH)— or —CH₂—C(CH₃)(COOH)—. A unit derived from a vinyl alcohol covers, for example, a unit obtained by polymerizing a monomer (for example a vinyl ester), followed by reacting (for example by hydrolysis) the polymer obtained so as to obtain units of formula —CH₂—CH(OH)—.

In the present patent application, the term hydrophobic is used in its usual sense of “having no affinity for water”; this means that the organic polymer from which it is formed, taken alone (of the same composition and the same molar mass), would form a two-phase macroscopic solution in distilled water at 25° C., at a concentration of greater than 1% by weight.

In the present patent application, the term hydrophilic is used in its usual sense of “having affinity for water”, i.e. being incapable of forming a two-phase macroscopic solution in distilled water at 25° C., at a concentration of greater than 1% by weight.

The term anionic or potentially anionic units means units that comprise an anionic or potentially anionic group and/or that have been categorized as such. Anionic units or groups are units or groups that bear at least one negative charge (generally associated with one or more cations such as cations of alkali metal or alkaline-earth metal compounds, for example sodium, or with one or more cationic compounds such as ammonium), irrespective of the pH of the medium in which the copolymer is present. Potentially anionic units or groups are units or groups that may be neutral or bear at least one negative charge depending on the pH of the medium in which the copolymer is present. In this case, they will be referred to as potentially anionic units in neutral form or in anionic form. By extension, the monomers may be referred to as anionic or potentially anionic monomers. Groups considered as being anionic are typically strong acid groups, for example with a pKa of less than or equal to 2. Groups considered as being potentially anionic are typically weak acid groups, for example with a pKa of greater than 2.

The term cationic or potentially cationic units means units that comprise a cationic or potentially cationic group, and/or that have been categorized as such. Cationic units or groups are units or groups that bear at least one positive charge (generally associated with one or more cations such as the chloride ion, the bromide ion, a sulfate group or a methyl sulfate group), irrespective of the pH of the medium into which the copolymer is introduced. Potentially cationic units or groups are units or groups that may be neutral or bear at least one positive charge depending on the pH of the medium into which the copolymer is introduced. In this case, they will be referred to as being potentially cationic units in neutral form or in cationic form. By extension, the monomers may be referred to as cationic or potentially cationic monomers.

The term neutral units means units that do not bear a charge, irrespective of the pH of the medium in which the copolymer is present.

In the present patent application, the weight ratio between blocks corresponds to the ratio between the masses of the monomers (or monomer mixtures) used for the preparation of the blocks (taking into account the variations in masses associated with any subsequent modification). The weight proportions of the blocks are the proportions relative to the total block copolymer, and correspond to the weight proportions of the monomers (or monomer mixtures) used for the preparation of the blocks, relative to the total amount of monomers used for preparing the block copolymer (taking into account the variations in masses associated with any subsequent modification).

In the present patent application, the term transfer agent means an agent that is capable of inducing a controlled radical polymerization in the presence of unsaturated monomers and optionally of a source of free radicals.

In the present patent application, a monomer composition used during a polymerization step is defined by the nature and relative amount of monomers. It may be a single monomer. It may be a combination of several monomers (comonomers), of different nature, in given proportions. Similarly, a macromolecular chain composition or a unit composition of a macromolecular chain is defined by the nature and relative amount of the monomers from which the units of the macromolecular chain are derived. It may be a macromolecular chain derived from a single monomer (homopolymeric chain). It may be a macromolecular chain whose units are derived from several monomers of different nature, in given proportions (copolymeric chain).

In the present patent application, a different monomer composition denotes a composition in which the nature of the monomer(s) and/or in which the proportions of the various monomers thereof are different. This is likewise the case by analogy for a different macromolecular chain or a different unit composition. A monomer composition comprising 100% of a monomer M¹ is different than a composition comprising 100% of a monomer M². A monomer composition comprising 50% of a monomer M¹ and 50% of a monomer A¹ is different than a composition comprising 10% of a monomer M¹ and 90% of a monomer A¹. A monomer composition comprising 50% of a monomer M¹ and 50% of a monomer A¹ is different than a composition comprising 50% of a monomer M¹ and 50% of a monomer A².

In the present patent application, for the sake of simplicity, the units derived from a monomer will occasionally be likened to the monomer itself, and reciprocally.

In the present patent application, an ethylenically unsaturated monomer is a compound comprising a polymerizable carbon-carbon double bond. It may be a monoethylenically unsaturated monomer, preferably an α-monoethylenically unsaturated monomer, or a polyethylenically unsaturated monomer. In the present patent application, for the various compounds of the star copolymers and for the various processes for preparing star copolymers, an ethylenically unsaturated monomer denotes a monoethylenically unsaturated and preferably an α-monoethylenically unsaturated monomer.

In the present patent application, the measured average molecular mass of a first block of a first part or of a copolymer denotes the number-average molecular mass in polyoxyethylene equivalents of a block or of a copolymer, measured by steric exclusion chromatography (SEC), with a calibration using polyoxyethylene stands. The measured average molecular mass of an n^{th} block or of an n^{th} part in an n-block or n-part copolymer is defined as the difference between the measured average molecular mass of the copolymer and the measured average molecular mass of the (n−1)-block or (n−1)-part copolymer from which it is prepared.

For the sake of simplicity, it is common practice to express the average molecular masses of the blocks or parts as “theoretical” or “target” average molecular masses starting from the amounts of monomers and of polymerization agents used, assuming a complete and perfectly controlled polymerization. Such calculations may be performed conventionally. For example, one macromolecular chain may form per transfer function of a transfer agent; to obtain the molecular mass, it suffices to multiply the average molecular mass of the units of a block by the number of units per block (numerical amount of monomer by numerical amount of transfer agent). The theoretical average molecular mass M_{block} of a block is typically calculated according to the following equation:

$${M}_{block} = {\sum }_{i} {M}_{i} * \frac{{n}_{i}}{{n}_{precursor}} ,$$

in which Mᵢ is the molar mass of a monomer i, nᵢ is the number of moles of the monomer i, n_{precursor} is the number of moles of functions to which the macromolecular chain of the block will be attached. The functions may originate from a transfer agent (or a transfer group) or an initiator, a preceding block, etc. If it is a preceding block, the number of moles may be considered as the number of moles of a compound to which the macromolecular chain of said preceding block has been attached, for example a transfer agent (or a transfer group) or an initiator. In practice, the theoretical average molecular masses are calculated from the number of moles of monomers introduced and from the number of moles of precursor introduced.

The theoretical or target average molecular mass of a block copolymer is considered as being the sum of the average molecular masses of each of the blocks.

### Block Copolymer

The copolymer is a linear block copolymer. Such architectures are known to those skilled in the art. They may especially be obtained via sequential polymerization processes, especially via processes in which the polymerizations are controlled radical polymerizations. The block copolymer may especially be:
a diblock copolymer (block A)-(block B),
a triblock copolymer (block A)-(block B)-(block A), or
a triblock copolymer (block B)-(block A)-(block B).

The weight ratio between block A and block B is preferably greater than or equal to 1 and preferably greater than or equal to 2. Such ratios may especially contribute toward improving the emulsifying or coemulsifying properties.

The copolymer may especially have a theoretical or measured average molecular mass of between 500 and 50 000 g/mol. The block(s) A may especially have a theoretical or measured average molecular mass of between 500 and 49 000 g/mol and preferably between 2000 and 48 000 g/mol. The block(s) B may especially have a theoretical or measured average molecular mass of between 250 and 20 000 g/mol and preferably between 500 and 10 000 g/mol.

The block copolymer preferably has an LCST of between 5° C. and 80° C. and preferably between 16° C. and 52° C. The monomers of the various blocks, in particular of block A, the proportions thereof and the molar masses thereof may be chosen to this effect.

### Block A

Block A is a block that has a lower critical solubility temperature (LCST). It comprises units A_{LCST} with a lower critical solubility temperature (LCST). It is derived from ethylenically unsaturated monomers, preferably from α-monoethylenically unsaturated monomers.

Block A comprises units A_{LCST}, i.e. units derived from a monomer A_{LCST} or from mixtures of monomers A_{LCST}.

The units A_{LCST} may be chosen especially from units derived from the following monomers A_{LCST}: vinylcaprolactam, N-ethylacrylamide, N,N′-methylethylacrylamide, N,N′-diethylacrylamide, N-isopropylacrylamide, N-isopropylmethacrylamide, 2-carboxylsopropylacrylamide, N-methyliso-propylacrylamide, N-propylacrylamide, N-acryloyl-N′-methylpiperazine, N-acryloyl-N′-ethylpiperazine, N-acryloyl-N′-propylpiperazine, N-propylmethacrylamide, N-(L)-(1-hydroxymethyl)propylmethacrylamide, N,N′-methyl-propylacrylamide and the monomers corresponding to the following formulae:

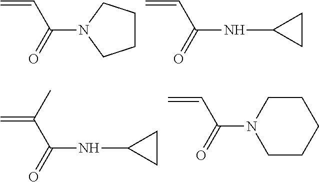

The units A_{LCST} may alternatively be chosen from the following units:
units comprising at least one polyether group, such as polyethylene oxide and/or propylene oxide) in the form of macromolecular chains with only one type of unit, or with several types of random or sequential units,
units comprising a polyvinyl methyl ether group (macromonomer),
units with an LCST derived from substituted acrylamide or methacrylamide monomers,
vinylcaprolactam,
macromonomers comprising units derived from substituted acrylamide or methacrylamide monomers (macromonomer).

The units A_{LCST} are preferably those derived from substituted acrylamide or methacrylamide monomers such as:
N-isopropylacrylamide (NIPAM),
N-ethylacrylamide,
vinylcaprolactam,
mixtures thereof.

The block A may comprise units Aₒₜₕₑᵣ derived from monomers whose homopolymers do not have an LCST. According to one preferred embodiment, block A comprises at least 50%, preferably at least 75% and preferably at least 90% by weight of units A_{LCST}. The units Aₒₜₕₑᵣ may especially be hydrophilic nonionic units N_{philic}, hydrophobic nonionic units N_{phobic}, cationic or potentially cationic units C_{C}, anionic or potentially anionic units C_{A}, or zwitterionic units Z.

As examples of units N_{phobic}, mention is made of the units B_{phobic} described below.

Block A is preferably such that a polymer free of block B, of the same composition and of the same molecular mass, has an LCST of between 5° C. and 80° C. and preferably between 16° C. and 52° C. The units (and thus the monomers) of block A, the proportions thereof and the molar mass of the block A may be chosen to this effect.

It is mentioned that the presence in block A of hydrophilic units, such as hydrophilic nonionic units N_{philic}, cationic or potentially cationic units C_{C}, anionic or potentially anionic units C_{A}, or zwitterionic units Z, may contribute toward increasing the LCST. It is thus possible to vary the LCST, for example within the above ranges.

It is mentioned that the presence in block A of hydrophobic units, such as hydrophobic nonionic units N_{phobic}, may contribute toward lowering the LCST. It is thus possible to vary the LCST, for example within the above ranges.

### Block B

Block B is a hydrophobic block, comprising hydrophobic units B_{phobic} derived from ethylenically unsaturated and preferably α-monoethylenically unsaturated hydrophobic monomers B_{phobic}.

As examples of monomers B_{phobic} from which the units B_{phobic} may be derived, mention may be made of:
vinylaromatic monomers such as styrene, α-methylstyrene, vinyltoluene, etc.,
vinyl or vinylidene halides, for instance vinyl chloride or vinylidene chloride, and aromatic vinyl halides such as styrene pentafluoride,
C₁-C₁₂ alkyl esters or alkylamides of α,β-monoethylenically unsaturated acids such as methyl, ethyl, butyl or 2-ethylhexyl acrylates and methacrylates, N-tert-butylacrylamide, etc.,
vinyl or allylic esters of saturated carboxylic acids such as vinyl or allyl acetates, propionates, versatates, stearates, etc.,
α,β-monoethylenically unsaturated nitriles containing from 3 to 12 carbon atoms, for instance acrylonitrile, methacrylonitrile, etc.,
α-olefins, for instance ethylene, propylene, etc.,
conjugated dienes, for instance butadiene, isoprene, chloroprene,
diethylene glycol ethyl ether acrylate or diethylene glycol ethyl ether methacrylate,
mixtures or combinations thereof.

Block B may comprise non-hydrophobic units Bₒₜₕₑᵣ, derived from monomers Bₒₜₕₑᵣ. According to one preferred embodiment, block B comprises at least 50%, preferably at least 75% and preferably at least 90% by weight of units Bₒₜₕₑᵣ. The units Bₒₜₕₑᵣ may especially be hydrophilic nonionic units N_{philic}, cationic or potentially cationic units C_{C}, anionic or potentially anionic units C_{A}, or zwitterionic units Z.

### Other Units

As examples of monomers N_{philic} from which units N_{philic} may be derived, mention may be made of:
hydroxyalkyl esters of α,β-ethylenically unsaturated acids, for instance hydroxyethyl or hydroxypropyl acrylates and methacrylates, glyceryl monomethacrylate, etc.,
α,β-ethylenically unsaturated amides, for instance acrylamide, methacrylamide, N,N-dimethylmethacrylamide, N-methylolacrylamide, etc.,
vinyl alcohol,
α,β-ethylenically unsaturated monomers that are precursors of hydrophilic units or segments such as vinyl acetate, which, once polymerized, can be hydrolyzed to generate vinyl alcohol units or polyvinyl alcohol segments,
vinyllactams, such as vinylpyrrolidone, or N-vinylcaprolactam,
α,β-ethylenically unsaturated monomers of ureido type and in particular 2-imidazolidinoneethyl methacrylamide (Sipomer WAM II from Rhodia),
nonethylene glycol methyl ether acrylate or nonethylene glycol methyl ether methacrylate,
mixtures or combinations thereof.

The cationic units C_{C} may be cationic units comprising cationic groups. The cationic groups may especially be groups of the type such as:
quaternary ammonium (of formula —N⁺R₃ in which R, which may be identical or different, is a group other than a hydrogen atom, for example an optionally substituted hydrocarbon-based group, where appropriate interrupted with heteroatoms, for example a linear or branched C₁-C₂₂ alkyl group, for example a methyl group),
inium (of formula ═N⁺R₂ in which R, which may be identical or different, is a group other than a hydrogen atom, one of which, where appropriate, forms part of a ring connected to the double bond, said ring being, where appropriate, aromatic, at least one of the groups R possibly being, for example, an optionally substituted hydrocarbon-based group, where appropriate interrupted with heteroatoms, for example a linear or branched C₁-C₂₂ alkyl group, for example a methyl group).

In the case of the groups of quaternary ammonium type, it may especially be a trimethylammonium group.

In the case of the inium groups, it may especially be a pyridinium group, preferably an alkylpyridinium group, preferably a methylpyridinium group.

The cationic group may be associated with a counterion (an anion). It may especially be a chloride, bromide, iodide, nitrate, methyl sulfate or ethyl sulfate ion. It is mentioned that the cationic units are not zwitterionic units comprising both a cationic group and an anionic or potentially anionic group (since they would then be of zero overall charge). In other words, the groups R mentioned below do not comprise any anionic substituents.

As examples of cationic monomers C_{C} from which the units C_{C} may be derived, mention may be made of:
trimethylammoniumpropyl methacrylate chloride,
trimethylammoniumethylacrylamide or methacrylamide chloride or bromide,
trimethylammoniumbutylacrylamide or methacrylamide methyl sulfate,
trimethylammoniumpropylmethacrylamide methyl sulfate (TAPMA-MeS),
(3-methacrylamidopropyl)trimethylammonium chloride (MAPTAC),
(3-acrylamidopropyl)trimethylammonium chloride (APTAC),
methacryloyloxyethyltrimethylammonium chloride or methyl sulfate,
acryloyloxyethyltrimethylammonium salts (ADAMQUAT),
1-ethyl-2-vinypyridinium or 1-ethyl-4-vinylpyridinium bromide, chloride or methyl sulfate,
N,N-dimethyldiallylammonium chloride (DADMAC),
dimethylaminopropylmethacrylamide-N-(3-chloro-2-hydroxypropyl)-trimethylammonium chloride (DIQUAT),
the monomer of formula:

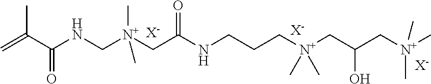

in which X⁻ is an anion, preferably chloride or methyl sulfate,
mixtures or combinations thereof.

The units C_{C} may especially be obtained by polymerization, so as to form at least one macromolecular chain, of monomers comprising the monomers Cc (where appropriate as a mixture with other monomers). They may also be obtained by polymerization, so as to form at least one precursor macromolecular chain C_{precursor}, of monomers comprising precursor monomers of units C_{C} (where appropriate as a mixture with other monomers), leading to precursor units of the units C_{C}, followed by chemical modification of the precursor units so as to obtain the units C_{C} in a macromolecular chain. Such modifications are known. They may be, for example, quaternizations, for example using dimethyl sulfate or quaternary haloalkylammoniums or quaternary haloalkylhydroxyalkylammoniums.

As examples of potentially cationic monomers C_{C} from which potentially cationic units C_{C} may be derived, mention may be made of:
N,N-(dialkylamino-ω-alkyl)amides of α,β-monoethylenically unsaturated carboxylic acids, for instance N,N-dimethylaminomethyl-acrylamide or -methacrylamide, 2-(N,N-dimethylamino)ethyl-acrylamide or -methacrylamide, 3-(N,N-dimethylamino)propyl-acrylamide or -methacrylamide and 4-(N,N-dimethylamino)butyl-acrylamide or -methacrylamide,
α,β-monoethylenically unsaturated amino esters, for instance 2-(dimethylamino)ethyl acrylate (DMAEA), 2-(dimethylamino)ethyl methacrylate (DMAEMA), 3-(dimethylamino)propyl methacrylate, 2-(tert-butylamino)ethyl methacrylate, 2-(dipentylamino)ethyl methacrylate or 2-(diethylamino)ethyl methacrylate,
vinylpyridines,
vinylamine,
vinylimidazolines,
monomers that are precursors of amino functions such as N-vinyl-formamide, N-vinylacetamide, etc., which give rise to primary amine functions by simple acidic or basic hydrolysis,
mixtures or combinations thereof.

As examples of monomers C_{A} from which the units C_{A} may be derived, mention may be made of:
monomers containing at least one carboxylic function, for instance α,β-ethylenically unsaturated carboxylic acids or the corresponding anhydrides, such as acrylic, methacrylic or maleic acid or anhydride, fumaric acid, itaconic acid, N-methacryloyl alanine, N-acryloylglycine and para-carboxystyrene, and the water-soluble salts thereof,
monomers that are precursors of carboxylate functions, for instance tert-butyl acrylate, which generate, after polymerization, carboxylic functions by hydrolysis,
monomers containing at least one sulfate or sulfonate function, for instance 2-sulfooxyethyl methacrylate, vinylbenzenesulfonic acid, allylsulfonic acid, 2-acrylamido-2-methylpropanesulfonic acid, sulfoethyl acrylate or methacrylate, and sulfopropyl acrylate or methacrylate, and the water-soluble salts thereof,
monomers containing at least one phosphonate or phosphate function, for instance vinylphosphonic acid, etc., ethylenically unsaturated phosphate esters such as the phosphates derived from hydroxyethyl methacrylate (Empicryl 6835 from Rhodia) and those derived from polyoxyalkylene methacrylates, and the water-soluble salts thereof,
mixtures or combinations thereof.

The units C_{A} may especially be obtained by polymerization, so as to form a macromolecular chain, of monomers comprising the monomers C_{A} (where appropriate as a mixture with other monomers). They may also be obtained by polymerization, so as to form at least one precursor macromolecular chain C_{precursor}, of monomers comprising precursor monomers of units C_{A} (where appropriate as a mixture with other monomers), leading to precursor units of the units C_{A}, followed by chemical modification of the precursor units so as to obtain the units C_{A} in the macromolecular chain. Such modifications are known. They may be hydrolyses of the units comprising a hydrolysable ester group (units derived from ethyl or tert-butyl acrylate or methacrylate, for example).

As examples of zwitterionic monomers Z from which zwitterionic units Z may be derived, mention may be made of:
monomers bearing a carboxybetaine group,
monomers bearing a sulfobetaine group, for example sulfopropyl dimethyl ammonium ethyl methacrylate (SPE), sulfoethyl dimethyl ammonium ethyl methacrylate, sulfobutyl dimethyl ammonium ethyl acrylate, sulfohydroxypropyl dimethyl ammonium ethyl methacrylate (SHPE), sulfopropyl dimethylammonium propyl acrylamide, sulfopropyl dimethylammonium propyl methacrylamide (SPP), sulfohydroxypropyl dimethylammonium propyl methacrylamide (SHPP), sulfopropyl diethyl ammonium ethyl methacrylate or sulfohydroxypropyl diethyl ammonium ethyl methacrylate,
monomers bearing a phosphonobetaine group, for instance phosphate-ethyl trimethylammonium ethyl methacrylate,
mixtures or combinations thereof.

### Process for Preparing the Block Copolymer

The ampholytic copolymer may be prepared via any suitable process. Such processes are known. The copolymer may especially be prepared via sequential polymerizations, preferably of controlled radical polymerization type.

It is especially possible to perform a process comprising the following steps to prepare the block copolymers:

step 1): polymerization, preferably via controlled radical polymerization, of monomers so as to obtain a first block chosen from block A and block B, or a precursor block of the first block,
step 2): polymerization, preferably via controlled radical polymerization, of monomers so as to obtain at least one second block chosen from block A if a block B or a precursor was obtained in step 1, and block B if a block A or a precursor was obtained in step 1), or a precursor block of the second block,
step 3), optional: if precursor blocks were obtained in steps 1) and/or 2), chemical modification of these blocks so as to obtain block A and block B.

Steps 1) and 2) are sequential. It is not excluded to perform other polymerization steps before step 3). It is possible to prepare block B during step 1) and then a block A during step 2), and optionally another block B during a subsequent step.

The process may especially comprise a step of deactivation of transfer groups borne by macromolecular chains, and/or of purification of the copolymer and/or of destruction of chemical modification and/or deactivation by-products. Such a step may be performed after the polymerization steps. It may be performed before or after step 3), if this is carried out. During the optional purification and/or deactivation and/or destruction step, the block copolymers obtained or the by-products may undergo a reaction for purification or destruction of certain species, for example via processes such as hydrolysis, oxidation, reduction, pyrolysis, ozonolysis or substitution. An oxidation step with hydrogen peroxide is particularly suitable for treating sulfureous species. It is mentioned that some of these reactions or operations may take place totally or partly during step 3). In this case, for these reactions or operations, the two steps are simultaneous.

Preferably, for the polymerization steps (especially steps 1) and 2)), living or controlled free-radical polymerization methods are performed, and particularly preferably controlled or living free-radical polymerization methods using a transfer agent comprising a transfer group of formula —S—CS—, especially known under the names RAFT and MADIX.

As examples of living or controlled polymerization processes, reference may be made especially:
to the processes of patent applications WO 98158974, WO 00/75207 and WO 01/42312, which use a free-radical polymerization controlled with control agents of xanthate type,
to the free-radical polymerization process controlled with control agents of dithioester or trithiocarbonate type of patent application WO 98/01478,
to the free-radical polymerization process controlled with control agents of dithiocarbamate type of patent application WO 99/31144,
the free-radical polymerization process controlled with control agents of dithiocarbazate type of patent application WO 02/26836,
to the free-radical polymerization process controlled with control agents of dithiophosphoroester type of patent application WO 02/10223,
to the process of patent application WO 99/03894, which uses a polymerization in the presence of nitroxide precursors, or the processes using other nitroxides or nitroxide/alkoxyamine complexes,
to the process of patent application WO 96/30421, which uses an atom-transfer radical polymerization (ATRP),
to the free-radical polymerization process controlled with control agents of iniferter type according to the teaching of Otu et al., Makromol. Chem. Rapid. Commun., 3, 127 (1982),
to the free-radical polymerization process controlled by degenerative iodine transfer according to the teaching of Tatemoto et al., Jap. 50, 127, 991 (1975), Daikin Kogyo Co. Ltd. Japan and Matyjaszewski et al., Macromolecules, 28, 2093 (1995),
to the free-radical polymerization process controlled with tetraphenylethane derivatives, disclosed by D. Braun et al., in Macromol. Symp. 111, 63 (1996), or alternatively
to the free-radical polymerization process controlled with organocobalt complexes, described by Wayland et al., in J. Am. Chem. Soc. 116, 7973 (1994),
to the free-radical polymerization process controlled with diphenylethylene (see WO 00/39169 or WO 00/37507).

Steps 1) and 2) may typically be performed by placing the monomers, a control agent and optionally at least one source of free radicals in contact. The source of free radicals may be an initiator. Such an initiator is preferably used during step 1). An initiator may again be introduced during step 2). Free radicals present in the reaction medium obtained from step 1) may also be used.

The polymerizations may be formed in the presence of free-radical initiators, which are known to those skilled in the art. Sodium persulfate may be used, for example. Amounts of initiators of from 5% to 50% by number relative to the amount of transfer agent may typically be used.

The polymerizations are advantageously performed in solution, preferably in aqueous, alcoholic or aqueous-alcoholic medium.

Transfer agents that are useful for performing the process (during steps 1) and 2)) are known to those skilled in the art and especially include compounds comprising a transfer group —S—CS—, for the implementation of polymerization processes known under the terms RAFT and/or MADIX. A transfer agent comprising a transfer group of formula —S—CS—O— (xanthate) is preferably used. Such processes and agents are detailed later.

During the polymerization steps, the preparation of a first block may be performed starting with monomers or a mixture of monomers, initiators and/or agents for promoting control of the polymerization (transfer agents containing —S—CS— groups, nitroxides, etc.), and growth of a second block on the first block may then be performed to obtain a diblock copolymer with monomer compositions different than those used for the preparation of the preceding block (especially with different monomers), and optionally with addition of initiators and/or agents for promoting control of the polymerization. These processes for preparing block copolymers are known to those skilled in the art. It is mentioned that the copolymer may have at the end or the center of the chain a transfer group or a residue of a transfer group, for example a group comprising an —S—CS— group (for example derived from a xanthate, a dithioester, a dithiocarbamate or a trithiocarbonate) or a residue of such a group.

It is mentioned that it would not constitute a departure from the context of the invention to use and to adapt preparation processes leading to triblock copolymers, where appropriate modified thereafter (for example during a specific step or during a step of destruction and/or deactivation and/or purification) so as to obtain diblock copolymers. It may especially be envisioned to use transfer agents comprising several transfer groups (for example trithiocarbonates Z—S—CS—S—Z) leading to telechelic copolymers of the type R-[(block B)-(block A)]_{w}, for instance triblocks of the type (core)-[(block A)-(block B)]ₓ (for example (block A)-(block B)-R-(block B)-(block A) as triblocks (block A)-(block B)-(core)-(block B)-(block A)), and then to break (section or “cleave”) the telechelic copolymers at the core, in order to obtain diblock copolymers (block A)-(block B). The sectioning may take place during a hydrolysis. In such cases, a person skilled in the art will adapt the working conditions to target average molecular masses equivalent to those indicated, for example by multiplying the amounts of monomers introduced by the number of transfer groups included in the transfer agent.

### Emulsion

The emulsion comprises an outer phase, and a liquid organic phase dispersed in the aqueous phase. It also comprises the block copolymer. The organic phase is typically a hydrophobic phase. Compounds and embodiments that are useful for the organic phase are detailed hereinbelow.

The amount of block copolymer may depend on the amount of organic phase. The weight ratio between the organic phase and the block copolymer may be, for example, between 50/50 and 1/0.01 (limits individually included or excluded), for example between 80/20 and 1/0.05 (limits individually included or excluded), for example between 1/0.5 and 1/0.5 (limits individually included or excluded). In the context of surface compositions, especially cosmetic compositions, the amount of amphiphilic block copolymer may be, for example, between 0.05% and 1% (limits individually included or excluded) and typically from 0.1% to 0.5% (limits individually included or excluded).

According to one preferred embodiment, it comprises at least one surfactant. The surfactant is chosen from anionic, cationic, amphoteric and nonionic surfactants, and mixtures or combinations thereof. In the present patent application, the amphoteric surfactants cover true amphoteric surfactants such as amphoacetates, and zwitterionic surfactants such as betaines. According to one particular embodiment, the emulsion comprises at least one anionic surfactant. The surfactant(s) preferably have a molar mass of less than 2000 g/mol and preferably 1000 g/mol. The total content of surfactants is generally between 0 and 30% (limits individually included or excluded) by weight. Surfactants that may be used are indicated below.

In the context of emulsions in cosmetic compositions, at least one anionic surfactant and at least one amphoteric surfactant may be used. Such combinations are particularly advantageous, especially for reasons of softness. For rinse-out or leave-in hair-conditioning compositions, the surfactant is preferably absent or present in an amount of less than or equal to 5% by weight, and it may preferably be a cationic surfactant. For compositions for treating the hair, such as shampoos, the surfactant content is advantageously between 10% and 20% (limits individually included or excluded) by weight. Such compositions may comprise salts, for example sodium or ammonium chloride, advantageously in an amount of less than or equal to 3% by weight. For compositions for treating the skin, such as shower gels, the surfactant content is advantageously between 5% and 15% (limits individually included or excluded) by weight. Cosmetic compositions also preferably comprise at least 2% by weight of salts, for example sodium or ammonium chloride. The weight proportion of anionic surfactants relative to the surfactants as a whole is preferably greater than or equal to 50% and preferably greater than or equal to 70%.

It is mentioned that the presence of surfactants, especially of anionic surfactants, may contribute toward increasing the LCST of the block copolymer in the emulsion. The LCST may thus be varied by modifying the content of surfactant(s), especially of anionic surfactant(s). It is mentioned that the presence of salts, especially NaCl, may contribute toward lowering the LCST of the block copolymer in the emulsion. The LCST may thus be varied by modifying the content of salt(s), especially of NaCl. For a given amphiphilic block copolymer, it is possible to vary the LCST by varying the amount and/or nature of surfactant(s), especially of anionic surfactant(s), or by varying the amount and/or nature of salt(s). For a targeted LCST, it is possible to adjust the composition of block A and/or to adjust the other ingredients present in the emulsion, especially the surfactants, especially the anionic surfactants, or the salts.

According to one advantageous embodiment, the weight ratio between the surfactant(s) and the amphiphilic block copolymer is less than or equal to 20/0.2, preferably less than or equal to 16/0.2, preferably less than or equal to 14/0.2 and preferably less than or equal to 10/0.2. It may especially be greater than or equal to 110.2, for example greater than or equal to 3/0.2, for example greater than or equal to 5/0.2.

According to one advantageous embodiment, the weight ratio between the anionic surfactant(s) and the amphiphilic block copolymer is less than or equal to 20/0.2, preferably less than or equal to 16/0.2, preferably less than or equal to 14/0.2 and preferably less than or equal to 10/0.2. It may especially be greater than or equal to 1/0.2, for example greater than or equal to 3/0.2, for example greater than or equal to 5/0.2.

According to one advantageous embodiment, the weight ratio between the total amount of surfactants and the total amount of polymers present in the emulsion is less than or equal to 20/0.2, preferably less than or equal to 16/0.2, preferably less than or equal to 14/0.2 and preferably less than or equal to 10/0.2. It may especially be greater than or equal to 1/0.2, for example greater than or equal to 3/0.2, for example greater than or equal to 5/0.2.

The composition of the emulsion is preferably such that the amphiphilic block copolymer has an LCST of between 5° C. and 80° C. and preferably between 16° C. and 52° C. The units (and thus the monomers) of block A, the proportions thereof and the molar mass of block A, and also the amount and nature of other ingredients such as surfactants or salts, may be chosen to this effect.

### Composition

The emulsion may form part of a composition for treating and/or modifying surfaces. It may especially be a cosmetic composition or a textile care composition, for example a laundry product or a fabric softener.

The treatment may be a laundry care treatment, performed in a domestic, industrial or institutional context. This treatment may be a cleaning and/or rinsing. In this treatment, the organic phase may be conveyed over an article made of textile fabric, especially cotton, during the rinsing operation and/or during the drying operation subsequent to the main cleaning operation when it is a detergent composition for cleaning, or during the subsequent drying operation when it is a rinsing composition. The organic phase may give the washed laundry softness, suppleness, anti-wrinkling, easy-ironing, abrasion-resistance, color-protection, fragrance-retention, etc. properties. It may especially be a silicone oil.

It is mentioned that cosmetic compositions generally comprise a cosmetically acceptable vector. In the present invention, the vector is an aqueous vector, in which the organic phase is dispersed.

The cosmetic compositions are preferably compositions intended to be rinsed out. Such compositions may be, for example, a shampoo, a shower gel or a hair conditioner. It may, however, be a haircare composition that is not intended to be rinsed out, for example a hair conditioner that is not intended to be rinsed out, a disentangling milk, a disentangling lotion, a smoothing lotion, a cuticle coat, a styling and/or restyling haircare product, an antisun product, a care cream, a makeup remover, a makeup, makeup-removing or moisturizing wipes, shaving foams, or styling or fixing foams.

According to advantageous embodiments, the composition is a skincare and/or haircare composition, preferably for cleansing and/or treating the skin and/or the hair, said composition being in the form of a fluid. It is advantageously a shower gel, a shampoo, a hair conditioner intended to be rinsed out, or a skin or hair mask intended to be rinsed off after use.

For hair conditioners intended to be rinsed out, the composition may be a fairly viscous formulation, for example a cream, in the form of an emulsion.

According to advantageous embodiments, the composition is a skincare and/or haircare composition, in the form of a fluid or in another form, preferably for treating and/or protecting and modifying the appearance of the skin and/or the hair, intended to be left on the skin and/or the hair after application.

It may be, for example, a hair conditioner not intended to be rinsed out, a disentangling milk, a disentangling lotion, a smoothing lotion, a cuticle coat, a styling haircare product, a styling and restyling haircare product, an antisun product (sun cream, sun milk or sun oil), a care cream, a makeup remover, a makeup, makeup-removing or moisturizing wipes, shaving foams, styling or fixing foams, or styling or fixing gels.

Examples of useful compositions that may be mentioned include:
the “sodium” compositions for shampoos typically comprising 12% to 16% by weight of sodium alkyl ether sulfate (for example sodium lauryl ether sulfate “SLES”) or a mixture of sodium alkyl ether sulfate and of sodium alkyl sulfate (for example sodium lauryl sulfate “SLS”), 1% to 3% of an amphoteric surfactant (for example cocamidopropyl betaine “CAPB”), 0.5% to 2% of a salt (for example sodium chloride);
the “ammonium” compositions for shampoos typically comprising 12% to 16% by weight of ammonium alkyl ether sulfate (for example ammonium lauryl ether sulfate “ALES”) or of a mixture of ammonium alkyl ether sulfate and of ammonium alkyl sulfate (for example ammonium lauryl sulfate “ALS”), 1% to 3% of an amphoteric surfactant (for example cocamidopropyl betaine “CAPB”), 0 to 2% of a salt (for example ammonium chloride);
the “sodium” compositions for shower gels typically comprising 6% to 10% by weight of sodium alkyl ether sulfate (for example sodium lauryl ether sulfate “SLES”) or of a mixture of sodium alkyl ether sulfate and of sodium alkyl sulfate (for example sodium lauryl sulfate “SLS”), 1% to 3% of an amphoteric surfactant (for example cocamidopropyl betaine “CAPB”), 2% to 4% of a salt (for example sodium chloride);
the “ammonium” compositions for shower gels typically comprising 6% to 10% by weight of ammonium alkyl ether sulfate (for example ammonium lauryl ether sulfate “ALES”) or a mixture of ammonium alkyl ether sulfate and of ammonium alkyl sulfate (for example ammonium lauryl sulfate “ALS”), 1% to 3% of an amphoteric surfactant (for example cocamidopropyl betaine “CAPB”), 0 to 4% of a salt (for example ammonium chloride).

The composition according to the invention may be a hair dye composition. Such compositions are known to those skilled in the art. It is pointed out that hair dye compositions may consist of several hair dye products intended to be mixed together by the user. In the present patent application, unless otherwise mentioned or specifically stated, the term “hair dye composition” covers either a complete composition or a product intended to be mixed with another by the user. In the present patent application, the term “dyeing the hair” covers any modification of the color of the hair, whether it is a matter of an actual dyeing operation, bleaching, or a combination of bleaching and dyeing.

The hair dye composition may comprise an oxidation base (oxidation dye precursors). It may comprise an oxidizing agent. It may comprise a coupler (coloration modifiers). It may comprise a direct coloring agent (direct dyes). The composition comprises a cosmetically acceptable vector. The composition may also comprise adjuvants.

According to one embodiment, it is a composition for long-lasting dyeing comprising an oxidation base, an oxidizing agent and optionally a coupler, preferably in the form of two products to be combined, a product comprising the oxidation base and a product comprising the oxidizing agent.

According to one embodiment, it is a composition for temporary or long-lasting dyeing comprising a direct dye and optionally an oxidizing agent.

According to one embodiment, it is a composition for bleaching or lightening the hair, comprising an oxidizing agent.

Direct dyes that may be mentioned include neutral, acidic or cationic nitrobenzene dyes, neutral, acidic or cationic azo direct dyes, neutral, acidic or cationic quinone and in particular anthraquinone direct dyes, azine direct dyes, methine direct dyes, tetraazapentamethine direct dyes, triarylmethane direct dyes, indoamine direct dyes and natural direct dyes.

Oxidizing agents that may be mentioned include hydrogen peroxide, urea peroxide, alkali metal bromates, persalts such as perborates and persulfates, peracids and enzymes, especially peroxidases, 2-electron oxidoreductases, and 4-electron oxygenases.

Couplers that may be mentioned include meta-phenylenediamines, meta-aminophenols, meta-diphenols, naphthalene-based couplers and heterocyclic couplers.

As cosmetically acceptable vectors that are preferred in the dye compositions, mention may be made of water and mixtures thereof with solvents, for example ethanol, isopropanol, polyols and polyol ethers, for instance 2-butoxyethanol, propylene glycol, and aromatic alcohols, for instance benzyl alcohol or phenoxyethanol.

The adjuvants may be anionic, nonionic, cationic or amphoteric surfactants, anionic, neutral or cationic polymers, mineral or organic thickeners, antioxidants, penetrants, sequestrants, fragrances, buffers, dispersants, conditioning agents, film-forming agents, ceramides, preserving agents or opacifiers. Needless to say, the ingredients mentioned above may be used as adjuvants in the hair dye compositions.

### Organic Phase

The compound(s) used in the organic phase are preferably chosen from compounds whose solubility in water does not exceed 10% by weight, over a temperature range between 20° C. and the emulsion preparation temperature.

Suitable compounds that may especially be mentioned include organic oils, of animal, plant or mineral origin, synthetic oils such as silicone oils (polyorganosiloxane), and also waxes of the same types, or mixtures thereof.

Among the plant oils and derivatives thereof that may especially be mentioned are:

almond oil (sweet almond oil), anhydrous lanolin oil, apricot kernel oil, avocado oil, castor oil, jojoba oil, olive oil, groundnut oil, sesame seed oil, sunflower oil, corn oil, cottonseed oil, hydrogenated vegetable oils, soybean oil, sulfonated castor oil, coconut oil, cocoa butter, wheatgerm oil, aloe vera, grapeseed oil, hazelnut oil, macadamia nut oil, St-Jean protuberance oil, walnut oil, hazelnut oil, borage oil, peach kernel oil, virgin coconut oil, baobab oil, avocado butter, palm oil, palm kernel oil, flax oil, copra oil, babassu oil and wheatgerm oil.

Among the oils of animal origin that may be mentioned, inter alia, are sperm whale oil, whale oil, seal oil, sardine oil, herring oil, shark oil, cod liver oil; pig fat or sheep fat (tallow).

As regards the mineral oils, mention may be made, inter alia, of naphthenic oils and paraffinic oils (petroleum jelly or petrolatum). Mention may also be made of perhydrosqualene and squalene.

As waxes of plant origin, mention may be made of carnauba wax.

As regards the mineral oils, mention may be made, inter alia, of petroleum fractions, naphthenic oils and liquid paraffins (petroleum jelly). Paraffin waxes may also be suitable for preparing the emulsion.

The products derived from the alcoholysis of the abovementioned oils may also be used.

It would not constitute a departure from the context of the present invention to use, as organic phase, at least one saturated or unsaturated fatty acid, at least one saturated or unsaturated fatty alcohol, at least one fatty acid ester, or mixtures thereof.

More particularly, said acids contain 8 to 40 carbon atoms, more particularly 10 to 40 carbon atoms and preferably 18 to 40 carbon atoms, and may comprise one or more conjugated or nonconjugated ethylenic unsaturations, and optionally one or more hydroxyl groups. As regards the alcohols, they may comprise one or more hydroxyl groups.

Examples of saturated fatty acids that may be mentioned include palmitic acid, stearic acid and behenic acid.

Examples of unsaturated fatty acids that may be mentioned include myristoleic acid, palmitoleic acid, oleic acid, erucic acid, linoleic acid, linolenic acid, arachidonic acid and ricinoleic acid, and also mixtures thereof.

As regards the alcohols, they more particularly contain 4 to 40 and preferably 10 to 40 carbon atoms, optionally one or more conjugated or nonconjugated ethylenic unsaturations and optionally several hydroxyl groups. Polymers comprising several hydroxyl groups may also be suitable, for instance polypropylene glycols.

Examples of alcohols that may be mentioned include those corresponding to the abovementioned acids.

As regards the fatty acid esters, these may advantageously be obtained from fatty acids chosen from the compounds named above. The alcohols from which these esters are prepared more particularly contain 1 to 6 carbon atoms. Preferably, they are methyl, ethyl, propyl or isopropyl esters.

Moreover, it is not excluded to use monoglycerides, diglycerides and triglycerides as organic phase.

According to one embodiment, the organic phase is based on a polyorganosiloxane. Polyorganosiloxanes are also known as silicones. The terms “silicone” and “polyorganosiloxane” mean any organosiloxane compound comprising alkyl groups (for example methyl) and/or functionalized with groups other than alkyl groups.

The polyorganosiloxane is advantageously (in shampoos and hair conditioners in particular) a nonvolatile water-insoluble polyorganosiloxane. It advantageously has a viscosity of between 1000 and 2 000 000 mPa·s and preferably between 5000 and 1 000 000 mPa·s (at 25° C.). The polyorganosiloxane may especially be a polydimethylorganosiloxane (“PDMS”, INCI name: dimethicone) or a polyorganosiloxane containing amine groups (for example Amodimethicone according to the INCI name), quaternary ammonium groups (for example the silicones Quaternium 1 to 10 according to the INCI name), hydroxyl groups (terminal or nonterminal), polyoxyalkylene groups, for example polyethylene oxide and/or polypropylene oxide (as end groups, as a block in a PDMS chain, or as grafts) or aromatic groups, or several of these groups.

The polyorganosiloxanes that are useful in the cosmetics field and the characteristics thereof are known to those skilled in the art.

The polyorganosiloxanes (silicones) are preferably present in the composition or in the concentrated ingredient in emulsion form (liquid droplets of silicone dispersed in the aqueous phase). The emulsion may especially be an emulsion with a mean droplet size of greater than or equal to 2 μm, or with a mean droplet size of between 0.15 μm and 2 μm, or with a mean droplet size of less than or equal to 0.15 μm.

The droplets of the emulsion may be of more or less large size. Reference may thus be made to microemulsions, miniemulsions or macroemulsions. In the present patent application, the term “emulsion” especially covers all these types of emulsion. Without wishing to be bound to any theory, it is pointed out that microemulsions are generally thermodynamically stable systems, generally comprising large amounts of emulsifiers such as surfactants c). The other emulsions are generally systems in thermodynamically unstable state, conserving for a certain time, in metastable state, the mechanical energy supplied during the emulsification. These systems generally comprise smaller amounts of emulsifiers.

The emulsions may be obtained by mixing an outer phase, which is preferably aqueous, polyorganosiloxane, polymer for aiding deposition and, in general, an emulsifier, followed by emulsification. This process may be referred to as in-situ emulsification.

The microemulsion droplet size may be measured on an emulsion prepared prior to its introduction into the cosmetic composition, by dynamic light scattering (DQEL), for example as described below. The apparatus used consists, for example, of a Spectra-Physics 2020 laser, a Brookhaven 2030 correlator and the associated computerware. Since the sample is concentrated, it is diluted in deionized water and filtered through a 0.22 μm filter in order finally to be at 2% by weight. The diameter obtained is an apparent diameter. The measurements are taken at angles of 90° and 135°. For the size measurements, besides the standard cumulative analysis, three exploitations of the self-correlation function are used (exponential sampling or EXPSAM described by Prof. Pike, the “nonnegatively constrained least squares” or NNLS method, and the CONTIN method described by Prof. Provencher), which each give a size distribution weighted by the scattered intensity, rather than by the mass or the number. The refractive index and the viscosity of water are taken into account:

According to one useful embodiment, the composition and/or the concentrated ingredient are transparent. The composition and/or the concentrated ingredient may, for example, have a transmittance of at least 90% and preferably of at least 95%, at a wavelength of 600 nm, for example measured using a Lambda 40 UV-Vis spectrometer, at a concentration of 0.5% by weight in water.

According to another particular embodiment, the composition or the concentrated ingredient are emulsions whose mean droplet size is greater than or equal to 0.15 μm, for example greater than 0.5 μm, or 1 μm, or 2 μm, or 10 μm, or 20 μm, and preferably less than 100 μm. The droplet size may be measured on an emulsion prepared prior to its introduction into the cosmetic composition, by optical microscopy and/or laser granulometry (Horiba LA-910 laser scattering analyzer). In this embodiment, the composition and/or the concentrated ingredient preferably comprise a proportion of less than 10% by weight of emulsifier relative to the weight of polyorganosiloxane.

Among the water-soluble silicones of the composition that may be mentioned, inter alia, are dimethicone copolyols (Mirasil DMCO sold by Rhodia).

As regards silicones in the form of water-insoluble dispersions or emulsions, nonvolatile water-insoluble organopolysiloxanes may appropriately be used, among which mention may be made of polyalkylsiloxane, polyarylsiloxane, and polyalkylarylsiloxane oils, gums or resins or nonvolatile water-insoluble functionalized derivatives thereof, or mixtures thereof.

Said organopolysiloxanes are considered as being water-insoluble and nonvolatile when their solubility in water is less than 50 g/liter and their intrinsic viscosity is at least 3000 mPa·s, at 25° C.

Examples of nonvolatile water-insoluble organopolysiloxanes or silicones that may be mentioned include silicone gums, for instance the diphenyl dimethicone gum sold by the company Rhodia Chimie, and preferably polydimethylorganosiloxanes with a viscosity at least equal to 6×10⁵ mPa·s, at 25° C., and even more preferentially those with a viscosity of greater than 2×10⁶ mPa·s, at 25° C., such as Mirasil DM 500000® sold by Rhodia.

According to the invention, the nonvolatile water-insoluble organopolysiloxane or silicone is in a form dispersed in the cosmetic composition or the concentrated ingredient containing it.

Among these low-viscosity silicones, mention may be made of cyclic volatile silicones and polydimethylorganosiloxanes of low mass.

It is also possible to use functionalized silicone derivatives, for instance amine derivatives directly in the form of emulsions or starting with a preformed microemulsion. These may be compounds known as amino silicones or hydroxyl silicones. Mention is made, for example, of the oil Rhodorsil amine 21637 (Amodimethicone) sold by the company Rhodia, and dimethiconol.

As polyorganosiloxanes that may be used mention is made especially of:
polyorganosiloxanes comprising units —Si(CH₂)₂O— and units —SiY(CH₂)O— in which Y is a —(CH₂)₃—NH(CH₂)₂—NH₂ or —(CH₂)₃—NH₂ group,
polyorganosiloxanes comprising units —Si(CH₂)₂O— and end units —HO—Si(CH₂)₂O— and/or non-end units —Si(CH₂)(OH)O—,
polyorganosiloxanes comprising units —Si(CH₂)₂O— and units —SiY(CH₂)O— in which Y is -L^{X}-Z^{x}-Palk in which L^{X} is a divalent bonding group, preferably an alkyl group, Z^{X} is a covalent bond or a divalent connecting group comprising a heteroatom, Palk is a group of formula [OE]ₛ-[OP]ₜ—X, in which OE is a group of formula —CH₂—CH₂—O—, OP is a group of formula —CH₂—CHCH₃—O— or —CHCH₃—CH₂—O—, X′ is a hydrogen atom or a hydrocarbon-based group, s is a mean number greater than 1, and t is a mean number greater than or equal to 0,
polyorganosiloxanes whose chain comprises at least one block comprising units of formula —Si(CH₂)₂O— and at least one block —[OE]ₛ-[OP]ₜ—,
polyorganosiloxanes comprising units —Si(CH₂)₂O— and/or units —Si(CH₂)RO— and/or —SiR₂O— and/or R—Si(CH₂)₂O— and/or H₃C—SiR₂— and/or R—SiR₂O— in which R, which may be identical or different, is an alkyl group other than a methyl group, an aryl group, an alkyl group, an alkylaryl group or an aralkyl group.

The following commercially available ingredients may especially be used as polyorganosiloxanes:
Mirasil DM 500000, Rhodia (INCI: Dimethicone), for example in the form of an emulsion with a particle size of 0.6 μm or 0.9 μm,
Mirasil DME-2, Rhodia (INCI: dimethicone)
Mirasil DME30, Rhodia (INCI: dimethicone)
Mirasil ADM-E, Rhodia (INCI: amodimethicone)
Dow Corning 1784 HVF, Dow Corning (INCI: Dimethiconol)
Dow Corning 1784 HMW, Dow Corning (INCI: Divinyldimethicone/dimethicone)
Mirasil DMCP-93, Rhodia (INCI: PEG/PPG-10/2 dimethicone)
Parsol SLX, DSM (INCI: Polysilicone-15)
Mirasil SM, Rhodia (INCI: Simethicone)
Mirasil DMCO, Rhodia (INCI PEG/PPG-22/24 Dimethicone)
Mirasil DM 100000, Rhodia (INCI: Dimethicone)
DC200 fluid 60000, Dow Corning (INCI: Dimethicone)
DC200 fluid 300000, Dow Corning (INCI: Dimethicone).

According to particular embodiments, the silicone oils are totally or partially formed from units of formula:

R′₃₋ₐRₐSiO_{1/2} (unit M) and/or R₂SiO (unit D)

in which formulae:
a is an integer from 0 to 3;
the radicals R are identical or different and represent:
   a saturated or unsaturated aliphatic hydrocarbon-based group containing from 1 to 10 carbon atoms;
   an aromatic hydrocarbon-based group containing from 6 to 13 carbon atoms;
   a polar organic group linked to silicon via an Si—C or Si—O—C bond;
the radicals R′ are identical or different and represent:
   a saturated or unsaturated aliphatic hydrocarbon-based group containing from 1 to 10 carbon atoms;
   an aromatic hydrocarbon-based group containing from 6 to 13 carbon atoms;
   an —OH function;
   an amino-functional or amido-functional group containing from 1 to 6 carbon atoms, linked to silicon via an Si—N bond.

Preferably, at least 80% of the radicals R represent a methyl group.

These silicones may optionally comprise preferably less than 5 mol % of units of formulae T and/or Q:

RSiO_{3/2} (unit T) and/or SiO₂ (unit Q)

in which formula R has the definition given above.

Examples of aliphatic or aromatic hydrocarbon-based radicals R that may be mentioned include the following groups:
alkyl, preferably optionally halogenated C₁-C₁₀ alkyl, such as methyl, ethyl, octyl or trifluoropropyl;
alkoxyalkylene, more particularly of C₂-C₁₀ and preferably of C₂-C₆, such as —CH₂—CH₂—O—CH₃;
alkenyls, preferably C₂-C₁₀ alkenyl, such as vinyl, allyl, hexenyl, decenyl or decadienyl;
alkenyloxyalkylene such as —(CH₂)₃—O—CH₂—CH═CH₂, or
alkenyloxyalkoxyalkyl such as —(CH₂)₃—OCH₂—CH₂—O—CH═CH₂ in which the alkyl portions are preferably of C₁-C₁₀ and the alkenyl portions are preferably of C₂-C₁₀;
aryls, preferably of C₆-C₁₃, such as phenyl.

Examples of polar organic groups R that may be mentioned include:
hydroxy-functional groups such as alkyl groups substituted with one or more hydroxyl or di(hydroxyalkyl)amino groups and optionally interrupted with one or more divalent hydroxyalkylamino groups. The term “alkyl” means a hydrocarbon-based chain preferably of C₁-C₁₀ and better still of C₁-C₆; examples of these groups are —(CH₂)₃—OH; —(CH₂)₄N(CH₂CH₂OH)₂; —(CH₂)₃—N(CH₂CH₂OH)—CH₂—CH₂—N(CH₂CH₂OH)₂;
amino-functional groups such as alkyl substituted with one or more amino or aminoalkylamino groups in which alkyl is as defined above; examples of these are —(CH₂)₃—NH₂; (CH₂)₃—NH—(CH₂)₂NH₂;
amido-functional groups such as alkyl substituted with one or more acylamino groups and optionally interrupted with one or more divalent alkyl-CO—N< groups in which alkyl is as defined above and acyl represents alkyl-carbonyl; an example is the —(CH₂)₃—N(COCH₃)—(CH₂)₂NH(COCH₃) group;
carboxy-functional groups such as carboxyalkyl optionally interrupted with one or more oxygen or sulfur atoms, in which alkyl is as defined above; an example is the —CH₂—CH₂—S—CH₂—COOH group.

Examples of radicals R′ that may be mentioned include:
alkyl groups, preferably optionally halogenated C₁-C₁₀ alkyl, such as methyl, ethyl, octyl or trifluoropropyl;
aryl groups, preferably of C₆-C₁₃, such as phenyl;
amino-functional groups such as alkyl or aryl substituted with amino, alkyl preferably being of C₁-C₆ and aryl denoting a cyclic aromatic hydrocarbon-based group preferably of C₆-C₁₃ such as phenyl; examples of these are ethylamino and phenylamino;
amido-functional groups such as alkylcarbonylamino in which alkyl is preferably of C₁-C₆; an example of these is methyl acetamido.

Concrete examples of “units D” that may be mentioned include: (CH₃)₂SiO; CH₃(CH═CH₂)SiO; CH₃(C₆H₅)SiO; (C₆H₅)₂SiO; CH₃(CH₂—CH₂—CH₂OH)SiO.

Concrete examples of “units M” that may be mentioned include: (CH₃)₃SiO_{1/2}; (CH₃)₂(OH)SiO_{1/2}; (CH₃)₂(CH═CH₂)SiO_{1/2}; (OCH₃)₃SiO_{1/2}; [O—C(CH₃)═CH₂]₃SiO_{1/2}: [ON═C(CH₃)]₃SiO_{1/2}; (NH—CH₃)₃SiO_{1/2}; (NH—CO—CH₃)₃SiO_{1/2}.

Concrete examples of “units T” that may be mentioned include: CH₃SiO_{3/2}; (CH═CH₂)SiO_{3/2}.

When the silicones contain reactive and/or polar radicals R (such as OH, vinyl, allyl, hexenyl, aminoalkyl, etc.), these radicals generally represent not more than 5% of the weight of the silicone and preferably not more than % of the weight of the silicone.

Volatile oils, for instance hexamethyldisiloxane, octamethyldisiloxane, decamethyltetrasiloxane, dodecamethylpentasiloxane, tetradecamethyl-hexasiloxane, hexadecamethylhexasiloxane; heptamethyl-3[(trimethylsilyl)-oxy]trisiloxane, hexamethyl-3,3-bis[(trimethylsilyl)oxy]trisiloxane; hexa-methylcyclotrisiloxane, octamethylcyclotetrasiloxane, decamethylcyclo-pentasiloxane, dodecamethylcyclohexasiloxane, pentamethyl[(trimethyl-silyl)oxy]cyclotrisiloxane, may preferably be used.

Similarly, nonvolatile silicones may be used, for instance polydimethylsiloxane and α,ω-bis(hydroxy)polydimethylsiloxane oils and gums and also polydimethylsiloxane, polyphenylmethylsiloxane and α,ω-bis(hydroxy)polydimethylsiloxane gums may be used.

α,ω-Bis(trimethyl)polydimethylsiloxane oils and α,ω-bis(hydroxy)poly-dimethylsiloxane oils are more particularly preferred.

As representative silicones that are most particularly suitable for the present invention, mention may be made especially of silicones of polydimethylsiloxane (dimethicone) and diphenyl dimethicone type.

It is mentioned that the organic phase may comprise an amount of water that does not exceed the water solubility limit in said organic phase (at a temperature of between 20° C. and the emulsion preparation temperature).

The organic phase may also comprise at least one active material.

Said active materials are in liquid form, soluble in the organic phase, dissolved in an organic solvent that is miscible in the organic phase, or alternatively in the form of a solid dispersed in said phase.

More particularly, the active materials are such that their solubility in water does not exceed 10% by weight between 20° C. and the emulsion preparation temperature.

In addition, the active materials preferably have a melting point of less than or equal to 100° C. and more particularly less than or equal to 80° C.

Examples of active materials in the cosmetics sector that may be mentioned include silicone oils belonging, for example, to the dimethicone family; lipophilic vitamins, for instance vitamin A.

In the paper sector, examples that may be mentioned include size resins and water-repellent resins, such as alkylketene dimer (AKD) or alkenyl-succinic anhydride (ASA).

In the detergency sector, possible active materials that may be mentioned include silicone antifoams, mineral and plant oils, and aminosilicones.

In the agrochemistry sector, the plant-protection active materials may be chosen from the family of α-cyanophenoxybenzyl carboxylates or α-cyanohalophenoxycarboxylates, the family of N-methylcarbonates comprising aromatic substituents, and active materials such as aldrin, azinphos-methyl, benfluralin, bifenthrin, chlorphoxim, chlorpyrifos, fluchloralin, fluoroxypyr, dichlorvos, malathion, molinate, parathion, permethrin, profenofos, propiconazole, prothiofos, pyrifenox, butachlor, metolachlor, chlorimephos, diazinon, fluazifop-P-butyl, heptopargil, mecarbam, propargite, prosulfocarb, bromophos-ethyl, carbophenothion or cyhalothrin.

It is similarly possible to use active materials such as those included in the composition of metal-working or metal-bending lubricants. The active material is usually an oil, an oil derivative or a fatty acid ester.

The active material may also be chosen from organic solvents or mixtures of such solvents that are sparingly miscible or immiscible in water, especially such as those used for cleaning or stripping, such as aromatic petroleum fractions, terpene compounds such as D- or L-limonenes, and solvents such as Solvesso®. Hydrocarbon-based oils, for instance liquid petroleum jelly, chlorinated solvents and C₁-C₄ alkyl diesters of at least one C₄-C₆ aliphatic diacid are also suitable as solvents. Mixtures of diacid esters, which are esters derived essentially from adipic acid, glutaric acid and succinic acid, the alkyl groups of the ester portion being chosen especially from methyl and ethyl groups, but also possibly being propyl, isopropyl, butyl, n-butyl and isobutyl; anisole; n-methylpyrrolidone; dimethyl sulfoxide; ketones, for instance cyclopentanone or methyl isobutyl ketone; polyalkylene glycols, for instance polyethylene glycol 400 or polypropylene glycol 400, are more particularly used.

In the case where the organic phase comprises one or more hydrophobic active materials that are different than the organic phase, their content more particularly represents 10% to 50% by weight of said inner organic phase.

Finally, the organic phase itself, as described previously, may be considered as a hydrophobic active material.

### Surfactants

The anionic surfactants may be chosen from the following surfactants:
alkyl ester sulfonates, for example of formula R—CH(SO₃M)-CH₂COOR′, or alkyl ester sulfates, for example of formula R—CH(OSO₃M)-CH₂COOR′, in which R represents a C₈-C₂₀ and preferably C₁₀-C₁₆ alkyl radical, R′ a C₁-C₆ and preferably C₁-C₃ alkyl radical and M an alkaline-earth metal cation, for example sodium, or an ammonium cation. Mention may be made most particularly of methyl ester sulfonates whose radical R is of C₁₄-C₁₆;
alkylbenzenesulfonates, more particularly of C₉-C₂₀, primary or secondary alkylsulfonates, especially of C₈-C₂₂, and allylglyceryl sulfonates;
alkyl sulfates, for example of formula ROSO₃M, in which R represents a C₁₀-C₂₄ and preferably C₁₂-C₂₀ alkyl or hydroxyalkyl radical; M represents a cation of the same definition as above;
alkyl ether sulfates, for example of formula RO(OA)ₙSO₃M in which R represents a C₁₀-C₂₄ and preferably C₁₂-C₂₀ alkyl or hydroxyalkyl radical; OA representing an ethoxylated and/or propoxylated group; M representing a cation of the same definition as above, n generally ranging from 1 to 4, for instance lauryl ether sulfate with n=2;
alkylamide sulfates, for example of formula RCONHR′OSO₃M in which R represents a C₂-C₂₂ and preferably C₆-C₂₀ alkyl radical, R′ represents a C₂-C₃ alkyl radical, M representing a cation of the same definition as above, and also the polyalkoxylated (ethoxylated and/or propoxylated) derivatives thereof (alkylamido ether sulfates);
saturated or unsaturated fatty acid salts, for example those of C₈-C₂₄ and preferably of C₁₄-C₂₀ and of an alkaline-earth metal cation, N-acyl N-alkyltaurates, alkylisethionates, alkylsuccinamates and alkylsulfo-succinates, sulfosuccinate monoesters or diesters, N-acyl sarcosinates and polyethoxycarboxylates;
phosphate monoesters and diesters, for example having the following formula:
   (RO)ₓ—P(═O)(OM)ₓ, in which R represents an alkyl, alkylaryl, arylalkyl or aryl radical, which are optionally polyalkoxylated, x and x′ being equal to 1 or 2, on condition that the sum of x and x′ is equal to 3, M representing an alkaline-earth metal cation.

The nonionic surfactants may be chosen from the following surfactants:
alkoxylated fatty alcohols; for example laureth-2, laureth-4, laureth-7, oleth-20
alkoxylated triglycerides
alkoxylated fatty acids
alkoxylated sorbitan esters
alkoxylated fatty amines
alkoxylated bis(1-phenylethyl)phenols
alkoxylated tris(1-phenylethyl)phenols
alkoxylated alkylphenols
products resulting from the condensation of ethylene oxide with a hydrophobic compound resulting from the condensation of propylene oxide with propylene glycol, such as the Pluronic products sold by BASF;
products resulting from the condensation of ethylene oxide with the compound resulting from the condensation of propylene oxide with ethylenediamine, such as the Tetronic products sold by BASF;
alkylpolyglycosides, for instance those described in U.S. Pat. No. 4,565,647 or alkyl glucosides;
fatty acid amides, for example of C₈-C₂₀, especially fatty acid monoalkanolamides, for example MEA cocamide or MIPA cocamide.

The amphoteric surfactants (true amphoteric surfactants comprising an ionic group and a potentially ionic group of opposite charge, or zwitterionic surfactants simultaneously comprising two opposite charges) may be chosen from the following surfactants:
betaines in general, especially carboxy betaines, for example lauryl betaine (Mirataine BB from the company Rhodia) or octyl betaine or cocobetaine (Mirataine BB-FLA from Rhodia); amidoalkyl betaines, for instance cocamidopropyl betaine (CAPB) (Mirataine BEM from the company Rhodia or Mirataine BET C-30 from Rhodia);
sulfobetaines or sultaines, for instance cocamidopropyl hydroxy sultaine (Mirataine CBS from the company Rhodia);
alkylamphoacetates and alkylamphodiacetates, for instance those comprising a coco or lauryl chain (Miranol C2M Conc NP, C32 and L32 especially, from the company Rhodia);
alkylamphopropionates or alkylamphodipropionates (Miranol C2M SF);
alkyl amphohydroxypropyl sultaines (Miranol CS);
alkylamine oxides, for example lauramine oxide (INCI).

The cationic surfactants may be chosen from primary, secondary or tertiary, optionally polyethoxylated fatty amine salts, quaternary ammonium salts such as tetraalkylammonium, alkylamidoalkylammonium, trialkylbenzylammonium, trialkylhydroxyalkylammonium or alkylpyridinium chlorides or bromides, imidazoline derivatives and amine oxides of cationic nature. An example of a cationic surfactant is cetrimonium chloride or bromide (INCI).

### Other Polymers

Besides the organic phase, the block copolymer and the possible surfactants, the composition may especially comprise polymers other than the block copolymer and, where appropriate, than the organic phase, which are synthetic or of natural origin. They may especially be thickeners, surface-treating agents, especially hair conditioners, or agents for aiding the deposition of surface-treating agents. Such polymers may especially be polymers that are partially or totally water-soluble. A synthetic polymer other than the block copolymer.

As regards synthetic polymers, it may especially be:
an optionally crosslinked polyacrylate and/or methacrylate, optionally comprising hydrophobic units, where appropriate in the form of aqueous dispersions in which the polymer becomes dissolved by increasing the pH,
a cationic or potentially cationic synthetic polymer, or an amphoteric or ampholytic synthetic polymer. Such compounds are especially referenced under the “Polyquaternium” INCI names listed below.

Mention is made especially of:
crosslinked polyacrylates, for example polymers of Carbopol or Carbomer type sold by SF Goodrich or Noveon, Acritamer sold by Rita or Tego Carbomer sold by Goldschmidt. These compounds may be typically present in an amount of from 0.1% to 3% and preferably from 0.3% to 2% by weight relative to the composition. Mention is made in particular of crosslinked copolymers of methacrylic acid and of a C₁-C₄ alkyl acrylate, such as the carbopol Aqua-SF1 from Noveon;
the PEG-20 C₁₀-C₃₀ alkyl acrylate/aminoacrylate/itaconate copolymers sold by National Starch under the name Structure Plus. These compounds may typically be present in an amount of from 0.1% to 3% and preferably from 0.3% to 2% by weight relative to the composition;
viscosity modifiers, gelling agents or texturing agents, for instance anionic acrylic copolymers of Aculyn type sold by ISP or Rohm & Haas.

As commercial compounds that may be used, mention is made of:
Carbopol ETD-2020, Noveon
Carbopol Aqua SF-1, Noveon
Carbopol 980, Noveon
Aculyn 22, Rohm & Haas
Structure Plus, National Starch.

As regards the polymers of natural origin, they may especially be cationic, nonionic or anionic derivatives, where appropriate hydrophobic. They may be, for example, polysaccharides or polysaccharide derivatives, keratin derivatives or proteins or protein derivatives. Cationic derivatives of natural polymers are especially referenced under the “Polyquaternium” INCI names listed below.

Mention may be made especially of polysaccharides and the noncationic derivatives thereof, such as cellulose derivatives, for instance hydroxypropylcellulose, carboxymethylcellulose, nonionic guar derivatives, for instance hydroxypropyl guar (for example the Jaguar HP products sold by Rhodia), locust bean gum, tara gum or cassia gum, xanthan gum (for example the Rhodicare products sold by Rhodia), succinoglycans (for example Rheozan sold by Rhodia), alginates, carrageenans, chitin derivatives or any other polysaccharide with a texturing function. These polysaccharides and derivatives thereof may be incorporated alone or in synergistic combination with other polysaccharides. These compounds may typically be present in an amount of from 0.1% to 3% and preferably from 0.3% to 1% by weight relative to the composition.

Mention may be made in particular of:
xanthan gum
succinoglycan
hydroxyethyl cellulose
hydroxypropyl guar
hydrolyzed keratins.

Additives are especially polymers of Polyquaternium type according to the INCI terminology familiar to those skilled in the art, for example chosen from the polymers of Table I below.

TABLE 1

| | Chemical nature | Commercial |
|---|---|---|
| INCI name | and/or CAS number | compounds |
| Polyquaternium-2 | CAS 63451-27-4 | Mirapol A15, |
| | | Rhodia |
| Polyquaternium-4 | CAS 92183-41-0 | Celquat L200, |
| | | H100, National |
| | | Starch |
| Polyquaternium-5 | CAS 26006-22-4 | |
| Polyquaternium-6 | DADMAC polymer | Merquat 1000, |
| | CAS 26062-79-3 | Nalco, |
| | | Mirapol 100, |
| | | Rhodia |
| Polyquaternium-7 | Copolymer of | Merquat 5500, |
| | DADMAC and of | Nalco; Mirapol |
| | acrylamide | 550, Rhodia |
| | CAS 26590-05-6 | |
| Polyquaternium-10 | Hydroxyethylcellulose | Polymer JR 400, |
| | modified with | Amerchol; |
| | trimethylammoniums | Celquat SC230M |
| | | or SC-240C, |
| | | National Starch |
| Polyquaternium-11 | Copolymers of | Gafquat 755N, |
| | vinylpyrrolidone and of | ISP; Luviquat |
| | quaternized | PQ11PN, BASF |
| | dimethylaminoethyl | |
| | methacrylate | |
| Polyquaternium-16 | CAS 29297-55-0 | Luviquat HM |
| | | 552, Luviquat |
| | | FC 370, BASF |
| Polyquaternium-17 | CAS 90624-75-2 | Mirapol AD1, |
| | | Rhodia |
| Polyquaternium-19 | CAS 110736-85-1 | |
| Polyquaternium-22 | Copolymer of | Merquat 280, |
| | DADMAC and of | 281, 298, Nalco |
| | acrylic acid | |
| Polyquaternium-24 | Hydroxyethylcellulose | Quatrisoft |
| | modified with | LM200, |
| | quaternary ammoniums | Amerchol |
| | containing long alkyl | |
| | chains | |
| Polyquaternium-27 | | Merquat 2001, |
| | | Nalco |
| Polyquaternium-28 | Copolymer of vinyl- | Gafquat HS 100, |
| | pyrrolidone and of | BASF |
| | MAPTAC | |
| Polyquaternium-29 | Chitosan derivative | Kytamer KCO, |
| | modified with | Amerchol, |
| | propylene oxide and | Lexquat CH |
| | quaternized with | |
| | epichlorohydrin | |
| Polyquaternium-31 | CAS 136505-02-7 and | Hypan HQ |
| | 139767-67-7 | |
| Polyquaternium-32 | CAS 254429-19-7 | |
| Polyquaternium-37 | CAS 35429-19-7 | |
| Polyquaternium-39 | | Merquat 3300, |
| | | 3331, Nalco |
| Polyquaternium-44 | | Luviquat Care, |
| | | BASF |
| Polyquaternium-46 | copolymers of vinyl- | Luviquat Hold, |
| | caprolactam, vinylpyr- | BASF |
| | rolidone, and cation- | |
| | ized vinylimidazole | |
| Guar hydroxypro- | | Jaguar C13S, |
| pylammonium | | C14S, C17, |
| chloride | | Excel, Rhodia |
| Hydroxypropyl | | Jaguar C162, |
| guar hydroxy- | | Rhodia |
| propylammonium | | |
| chloride | | |
| Polyquaternium-67 | Hydroxyethylcellulose | Softcat SL, |
| | modified with | Amerchol |
| | quaternary ammoniums | |
| | containing long alkyl | |
| | chains and with short- | |
| | chain quaternary | |
| | ammoniums | |
| Polymethacryl- | MAPTAC polymer | Polycare 133, |
| amidopropyl- | | Rhodia |
| trimonium chloride | | |
| Acrylamidopropyl- | | Salcare SC-60, |
| trimonium | | Ciba |
| chloride/acrylamide | | |
| copolymer | | |

### Other Ingredients

Besides the compounds mentioned above, the compositions may comprise other ingredients usually used for the applications for which they are intended. For cosmetic compositions, they may especially be UV-screening agents, dispersants, sequestrants, emollients, humectants, fixative resins, film-forming polymers, dyes, pigments, nacreous agents (for example compounds based on ethylene glycol or polyethylene glycol distearate), fragrances or preserving agents. For textile care compositions, they may especially be fragrances, detergency adjuvants (for example STPP, polycarboxylates, silicates or zeolites), antisoiling agents, antifouling agents, film-forming polymers, color-fixing agents or enzymes.

### Use—Implementation

The emulsions of the invention may be applied to a surface (for example the skin, the hair or a textile surface). The application may be performed by any means, where appropriate after dilution. The application mode may depend on the use made thereof. It may be, for example, an application with the hands (for example for cosmetic compositions), by dipping (for example for laundry care compositions), by spraying, or by industrial treatment. According to one advantageous mode, the application and the optional dilution are performed at a temperature below the LCST of block A and/or of the copolymer, taking into account any influence of other ingredients. According to one advantageous mode, the temperature is then raised above the LCST. This raising may bring about destabilization of the emulsion and promote the deposition of the organic phase onto the substrate. The temperature may be raised by any means. It may be a case of bringing into contact with a hotter surface (the temperature rise may take place at the actual moment of application), rinsing or diluting with hot water, or any other means. For the cosmetic compositions, the temperature rise may occur during contact with the skin (typically at about 37° C.) and/or during rinsing with hot water. According to one advantageous mode, the LCST is less than or equal to 37° C., and preferably greater than or equal to 25° C. Such an embodiment makes it possible to destabilize the emulsion at the time of contact with the skin and/or of rinsing. The effect of the body temperature may thus, in certain cases, be observed visually by the user as a sign of the efficacy of the composition for treating the skin and/or the hair.

Other details or advantages of the invention may appear in the light of the examples that follow, without any limiting nature.

The following abbreviations are used

### NIPAM: N-isopropylacrylamide

BuA: butyl acrylate

In the examples, the letter C indicates a comparative example.

### EXAMPLE 1

### Preparation of Block Copolymers

### Example 1.1

### pBuA₂₀₀₀-b-p(NIPAM)₈₀₀₀ Copolymer

This is a copolymer comprising a polybutyl acrylate block and a polyNIPAM block.

The theoretical molar mass of the pBuA block is 2000 g/mol.

The theoretical molar mass of the pNIPAM block is 8000 g/mol.

5.21 g (25 mmol) of O-ethyl-S-(1-methoxycarbonyl)ethyldithiocarbonate (Rhodixan A1, available from Rhodia), 23.9 g of ethanol and 50 g (390 mmol) of butyl acrylate (BuA) are placed in a 250 ml round-bottomed flask equipped with a magnetic stirrer and a condenser. The solution is degassed using a stream of nitrogen. The temperature is raised to 75° C., and 0.6 g (3.1 mmol) of 2,2′-azobismethylbutyronitrile (AMBN) is added. The reaction is allowed to proceed at 75° C. for 3 hours. A first pBuA block dissolved in ethanol is obtained.

The BuA conversion is greater than 99% (determined by proton NMR).

Measured molar masses: Mₙ=1900 g/mol, M_{w}/Mₙ=1.63.

8 g of the pBuA solution obtained, 23.8 g of ethanol, 20 g of NIPAM (177 mmol) and 240 mg (1.5 mmol) of AMBN are mixed together. The reaction is maintained at 75° C. for 9 hours.

The BuA conversion is greater than 98% (determined by proton NMR).

### Example 1.2C

### p(NIPAM)₇₀₀₀-b-PDMS₂₇₀₀-p(NIPAM)₇₀₀₀ Copolymer

This is a copolymer comprising a polydimethylsiloxane central block and two polyNIPAM side blocks.

This copolymer is prepared as taught in Example 1 of document WO 2007/012 763.

### Example 1.3

### pBuA₂₀₀₀-b-p(NIPAM-co-AM)₈₀₀₀ Copolymer

The process is performed as in Example 1.1, replacing 22 mol % of NIPAM with 22 mol % of acrylamide (AM).

### Example 1.4

### pBuA₂₀₀₀-b-p(NIPAM-co-SPP)₈₀₀₀ copolymer

The process is performed as in Example 1.1, replacing 10 mol % of NIPAM with 10 mol % of SPP.

### Example 1.5

### pBuA₂₀₀₀-b-p(NIPAM-co-BuA)₈₀₀₀ Copolymer

The process is performed as in Example 1.1, replacing 5 mol % of NIPAM with 5 mol % of butyl acrylate.

### Example 1.6

### pBuA₂₀₀₀-b-p(NIPAM-co-N-t-BuAm)₈₀₀₀ Copolymer

The process is performed as in Example 1.1, replacing 5 mol % of NIPAM with 5 mol % of N-tert-butylacrylamide (N-t-BuAm).

### Example 1.7

### pBuA₂₀₀₀-b-p(NIPAM-co-N-t-BuAm)₈₀₀₀ Copolymer

The process is performed as in Example 1.1, replacing 14 mol % of NIPAM with 14 mol % of N-tert-butylacrylamide (N-t-BuAm).

### EXAMPLE 2

### Preparation of Emulsions

Emulsions of a silicone oil (PDMS—Mirasil® DM 60 000, available from Rhodia) in water are prepared, in the presence of the block copolymers of Example 1 and of a nonionic surfactant (C₁₂-C₁₄ alcohol ethoxylated 7 times, Empilan KBE7/90, available from Huntsman).

The amounts are as follows:
oil/water ratio: 80/20 (by weight)
amount of block copolymer: 10% by weight, relative to the oil
amount of nonionic surfactant: 4.8% by weight, relative to the oil.

The preparation procedure is as follows:

An aqueous solution comprising the block copolymer and the nonionic surfactant, at concentrations suited to the amounts indicated above for the finished emulsion, is prepared.

The emulsion is prepared by adding silicone oil to the aqueous solution, for 10 minutes, with rotation of a frame paddle spinning at 400 rpm.

Emulsions with a mean droplet size (Horiba LA-910, after diluting the emulsion so as to have a transmittance of 80%) close to 1 μm are obtained.

Example 2.0C: emulsion prepared without block copolymer.

Example 2.1: emulsion prepared using the block copolymer of Example 1.1.

Example 2.2C: emulsion prepared using the block copolymer of Example 1.2C.

Example 2.3: emulsion prepared using the block copolymer of Example 1.3.

Example 2.4: emulsion prepared using the block copolymer of Example 1.4.

Example 2.5: emulsion prepared using the block copolymer of Example 1.5.

Example 2.6: emulsion prepared using the block copolymer of Example 1.6.

Example 2.7: emulsion prepared using the block copolymer of Example 1.7.

The behavior of the emulsions after dilution is observed as a function of the temperature: the emulsion is diluted with water so as to obtain a silicone oil concentration of 20%, at room temperature. At room temperature, the emulsions are stable. The emulsions are heated on a hotplate, with control of the temperature of the emulsion. Beyond a critical temperature, flocculation of the emulsion is observed, and a deposit forms if it is left to stand. It is observed that the flocculation is reversible if cooling is allowed.

| Emulsion | Flocculation temperature |
|---|---|
| Example 2.0C | No critical temperature - |
| | no flocculation |
| Example 2.1 | 31° C. |
| Example 2.2C | 31° C. |
| Example 2.3 | 48° C. |
| Example 2.4 | 52° C. |
| Example 2.5 | 23° C. |
| Example 2.6 | 28° C. |
| Example 2.7 | 23° C. |

### EXAMPLE 3

### Preparation of Shampoos Containing the Emulsions

The following shampoo formulations are prepared (the amounts are indicated as weight of active material, unless otherwise indicated):

| Ingredient | References | Example 3.1 | Example 3.2 | Example 3.3 | Example 3.4C |
|---|---|---|---|---|---|
| SLES | Empicol | 14% | 14% | 14% | 14% |
| | ESB 3/M | | | | |
| | (Huntsman) | | | | |
| CAPB | Mirataine | 2% | 2% | 2% | 2% |
| | BET C-30 | | | | |
| NaCl | | 1.5% | 1.5% | 1.5% | 1.5% |
| Emulsion | | Example 2.1: | Example 2.1: | Example 2.1; | Example 2.3C: |
| | | 1% (by weight | 1% (by weight | 1% (by weight | 1% (by weight |
| | | of silicone oil - | of silicone oil - | of silicone oil - | of silicone oil - |
| | | comprises | comprises | comprises | comprises no |
| | | 0.1% polymer) | 0.1% polymer) | 0.1% polymer) | polymer) |
| Polymer of | | | 0.2% | | |
| Example 1.1 | | | | | |
| Cationic | Jaguar ® | | | 0.1% | |
| guar | C17, Rhodia | | | | |
| Total | | 0.1% | 0.3% | 0.2% | |
| amount of | | | | | |
| polymer | | | | | |

Locks of hair are treated with these shampoos and are then rinsed in water at 38° C. The locks are analyzed by X-ray fluorescence (detection of the silicon peak). A silicone deposit greater than that of Example 3.4C is observed for Examples 3.1, 3.2 and 3.3.

1-17. (canceled)

18. An emulsion comprising:
an aqueous outer phase,
a liquid organic phase dispersed in the aqueous phase, and
an amphiphilic linear block copolymer comprising a hydrophilic block A and a hydrophobic block B,
wherein:
block A comprises a block with a lower critical solubility temperature (LCST) comprising units A_{LCST} having a lower critical solubility temperature (LCST),
block B is a hydrophobic block, comprising hydrophobic units B_{phobic}, and
block A and block B are derived from ethylenically unsaturated monomers.

19. The emulsion of claim 18, wherein the block copolymer comprises
a diblock copolymer (block A)-(block B),
a triblock copolymer (block A)-(block B)-(block A), or
a triblock copolymer (block B)-(block A)-(block B).

20. The emulsion of claim 18, wherein block A is comprised such that a polymer of the same composition and molecular mass as block A, and which is free of block B, has an LCST ranging from 5° C. to 80° C.

21. The emulsion of claim 20, wherein the LCST ranges from 16° C. to 52° C.

22. The emulsion of claim 18, wherein the block copolymer has an LCST ranging from 5° C. to 80° C.

23. The emulsion of claim 22, wherein the LCST ranges from 16° C. to 52° C.

24. The emulsion of claim 18, wherein block A comprises at least 50% by weight of units A_{LCST}.

25. The emulsion of claim 18, wherein the units A_{LCST} are derived from monomers comprising:
N-isopropylacrylamide (NIPAM),
N-ethylacrylamide,
vinylcaprolactam, or
mixtures thereof.

26. The emulsion of claim 18, wherein the units B_{phobic} are derived from monomers comprising:
styrene, a-methylstyrene, or vinyltoluene;
vinyl chloride, vinylidene chloride, or styrene pentafluoride;
methyl, ethyl, butyl or 2-ethylhexyl acrylates, or methyl, ethyl, butyl or 2-ethylhexyl methacrylates;
vinyl or allyl acetate, propionate, versatate or stearate;
acrylonitrile or methacrylonitrile;
ethylene or propylene;
butadiene, isoprene, or chloroprene; or
mixtures or combinations thereof.

27. The emulsion of claim 18 wherein the weight ratio of block A to block B is greater than or equal to 1.

28. The emulsion of claim 18, further comprising at least one surfactant comprising an anionic, cationic, amphoteric or nonionic surfactant, or a mixture or combination thereof.

29. The emulsion of claim 18, wherein the liquid organic phase comprises plant oils, mineral oils, silicone oils, or a mixture thereof.

30. The emulsion of claim 18, wherein said emulsion is a component in a composition for treating and/or modifying surfaces.

31. The emulsion of claim 30, wherein the composition comprises a cosmetic or textile care composition.

32. The emulsion of claim 30, further comprising at least one anionic surfactant.

33. A process for forming an emulsion comprising:
adding an amphiphilic linear block copolymer to an composition to form a liquid organic phase dispersed in an aqueous phase,
wherein said copolymer comprises a hydrophilic block A and a hydrophobic block B, and further wherein:
block A comprises a block with a lower critical solubility temperature (LCST) comprising units A_{LCST} having a lower critical solubility temperature (LCST),
block B is a hydrophobic block, comprising hydrophobic units B_{phobic}, and
block A and block B are derived from ethylenically unsaturated monomers.

34. The process of claim 33, wherein said emulsion further comprises a co-emulsifier.

35. A process for triggering the destabilization of an emulsion comprising:
increasing the temperature of an emulsion comprising:
an aqueous outer phase,
a liquid organic phase dispersed in the aqueous phase, and
an amphiphilic linear block copolymer comprising a hydrophilic block A and a hydrophobic block B,
wherein:
block A comprises a block with a lower critical solubility temperature (LCST) comprising units A_{LCST} having a lower critical solubility temperature (LCST),
block B is a hydrophobic block, comprising hydrophobic units B_{phobic}, and
block A and block B are derived from ethylenically unsaturated monomers.

36. The process of claim 35, wherein increasing the temperature of the emulsion results in the deposition of at least part of the organic phase onto a surface.
